(19) United States
(12) Patent Application Publication
(10) Pub. No.: US 2006/0104329 A1
(43) Pub. Date: May 18, 2006

(54) Apparatus for diode laser beam quality control

(76) Inventors: Zhijiang Wang, Diamond Bar, CA (US); Ying Wang, Diamond Bar, CA (US)

Correspondence Address: YING WANG, 23637 COUNTRY VIEW DR., DIAMOND BAR, CA, 91765, US

(21) Appl. No.: 11/271,028

(22) Filed: Nov. 12, 2005

Related U.S. Application Data
(60) Provisional application No. 60/627,077, filed on Nov. 12, 2004.

(51) Int. Cl. H01S 3/082

(52) U.S. Cl. 372/97

(57) ABSTRACT

Method and apparatus are disclosed for controlling the beam quality from LDA by using external cavity feedback to improve the slow axis divergence of LDA to be close to diffraction limited. The external cavity described in the present invention will only reflect beams in a predetermined direction, and inject the reflected beam back to LDA preferably in the direction with maximum gain and generate laser output in a different direction. The external cavity disclosed will provide injection feedback control for all the emitters in LDA at the same time so that the beam quality of LDA can be improved.

### CROSS-REFERENCES TO RELATED APPLICATIONS

This continuation application claims the benefit of U.S. Provisional Patent Application No. 60/627,077, filed Nov. 12, 2004, entitled “Apparatus for Diode Laser Beam Quality Control”.

### FIELD OF THE INVENTION

The present invention relates to a method and apparatus for diode laser beam quality control wherein external cavity feedback is used to improve the slow axis divergence to be close to diffraction limited.

### BACKGROUND OF THE INVENTION

Beam quality factor M² has been used to characterize the laser beam quality as defined by the International Standard ISO/DIS 11146. When the laser beam quality reaches diffraction limited, M²=1. Since beam quality is directly related to the application field of a laser, controlling or restricting laser modes and improving laser beam divergence have been one of the major topics in laser development.

Semiconductor laser or diode laser has the highest electric efficiency among all kinds of laser devices. However high power laser diode array (LDA) suffers a very high divergence in the slow axis, M²>1000, which greatly limited is applications. Only laser diodes with mW power level are close to diffraction limited. The laser cavity consists of a gain-guided waveguide structure between the front and rear mirror. The active layer has a dimension in microns in both thickness and width, and therefore can not generate higher power in single mode. The power level can be increased to 1 W or even over 10 W by increasing the width of emitter, which comprises a dense gain-guided waveguide array. Such array is commonly called broad area semiconductor laser (BAL) with the emitter aperture dimension being as large as 1 μm×100 μm or even 1 m×1000 μm. BAL can be further grouped into LDA to deliver power of 20 W to 60 W. The commercial LDA's often have an length of about 1 cm consisting many emitters arranged along the slow axis, and the LDA's can be stacked together for even higher power.

There is a relatively long history in improving the beam quality of laser diode using external cavity or other techniques. (IEEE J. Quan. El. 32 (1996) 996; Opt. Express, 12 (2004) 609) The efforts are mainly for improving the beam quality of BAL, in which the external feedback using a mirror stripe has been rather successful, obtaining power of about 1 W with M² close to 1, or of several watt with M² improved by a factor of 16. (Appl. Phys. Lett. 50 (1987) 1465; Opt. Lett. 27 (2002) 167; SPIE Proceeding, 5336 (2004) 33) However, for LDA such external cavity is difficult to be realized. The difficulty is determined by the fact that the emitters in LDA are close to each other, and the beams from these emitters overlap quickly after traveling a very short distance from the emitters due to the large slow axis divergence. Gao et al uses multi-stripe mirror as the external cavity of LDA, and reduces the divergence by a factor of 4. (Opt. Lett. 29 (2004) 361). But the alignment in this method is very difficult, and the divergence angle is not fully controlled.

In U.S. Pat. Nos. 6,650,665, 6,414,973 and a few other filings, Hwu discloses a mode controlling device for capturing a highly divergent, multi-mode laser beam received from a high-power broad area laser (BAL) source, wherein the mode controlling device comprises an external optical reflector having a non-planar profile positioned to receive the multi-mode laser beam, wherein the optical reflector comprises a focal length from the surface of the optical reflector, wherein the laser source is positioned at the focal distance from the surface of the optical reflector, and wherein a narrow, single-mode laser beam with a non-uniform intensity profile is produced by the mode controlling device; and a frequency altering device configured to receive the single-mode laser beam, the frequency-altering device configured to produce a frequency altered laser light. In this disclosure, the optical path of the output laser beam from BAL and the optical path of the injection beam into BAL from the mode controlling device such as a volume grating coincide (beam perpendicular to the facet). In addition, many of the optical layouts in the disclosure are not practical or realizable. In another disclosure in U.S. Pat. No. 6,212,216, Pillai described a micro laser apparatus comprises at least one multimode micro laser having an emission aperture and two external cavity sections. The external cavity means embracing the laser has an output section that includes spatial filter means, such as an optical waveguide or a single mode fiber core, and imaging means for imaging at the spatial filter means. The cavity output section also includes feedback means for causing a fraction of the optical energy in the selected lasing lobe component(s) to be fed back to the laser for amplification by the laser. In Pillai's disclosure, the cavity return section is used to receive the amplified lasing lobe component after reflection from the laser. Return means in the return section efficiently returns to the laser means at least a portion of the amplified and reflected lasing lobe component. The apparatus disclosed by Pillai restricts the mode with a single mode spatial filter, which can be difficult to realize technically.

By using grating as external cavity for feedback, it is possible to make the laser spectrum more stable and narrower. Volodin et al (Adv. Solid-State Photonics. Tops v.94, (2004) p. 491) uses volume Bragg grating as external cavity to narrow the LDA spectrum width, but the divergence is not improved. Yiou et al (Opt. Lett. 28 (2003) 242) uses volume grating to improve the divergence of LDA, but the efficiency is low. In these two studies, the grating used are partially transparent grating. When such gratings are used as external cavity, the optical path of the output laser beam from BAL and the optical path of the injection beam into BAL are coincident, and the beam is normal (or perpendicular) to the BAL (or LDA) surface (or facet). This is one of the main reasons of poor efficiency and failure in improving the divergence. Both of these techniques fail to understand the mechanism of volume grating in restricting beam divergence, that is, the necessity of oblique incidence with a large incidence angle. Although Yiou et al tries to use volume grating to reduce the divergence angle, their formula for angular selectivity of volume grating (Δθ=nP/e) is wrong because it shows no relationship with incident angle. On the other hand, the external cavity layout is unusable for LDA's.

According to the theory of volume grating (Bell Sys. Tech. J. 48 (1969) 2909; J. Lightwave Tech. 15 (1997) 1263), when
kL=πΔn·L/λ==1,2,3
the reflectivity of a grating will be 58, 93, and 99%, respectively, where L is the length of optical path in grating, Δn is the amplitude of the refractive index perturbation, and λ is wavelength. Therefore, it is not difficult to realize volume grating with high reflectivity.

Based on the BAL mode theory (IEEE J. Quan. El. 26(1990) 270; 32 (1996) 996), the mode of the highest order has the highest gain (close to the maximum divergence angle). Therefore, when using external cavity for feedback injection, it is important to use proper angle of injection and angle of output laser beam from the other side of symmetry in order to achieve good results. (SPIE 5336 (2004)33).

### SUMMARY OF THE INVENTION

The purpose of this invention is to control the beam quality from LDA by using external cavity feedback to improve the slow axis divergence of LDA to be close to diffraction limited. The external cavity described in the present invention will only reflect beams in a predetermined direction, and inject the reflected beam back to LDA in the direction with maximum gain and generate laser output from different direction. The external cavity disclosed will provide injection feedback control for all the emitters in LDA at the same time so that the beam quality of LDA can be improved.

The disclosed external cavity comprises volume grating with angular selectivity. This will include volume grating with large incident angle that has a high angular selectivity, and volume grating with normal incident angle that has relatively weak angular selectivity.

The disclosed external cavity may include telescope or other optical system for angular amplification, which will transform a volume grating or a mirror with weak angular selectivity into an external cavity with high angular selectivity.

The disclosed external cavity may comprise an optical system that focus beams from a predetermined direction, and a reflector that is located at the focal point of said optical system to send beam at the focal point back from the path they come. Said reflector should have a substantially high reflectivity, and can be selected from conventional optical components including spherical mirrors, plane mirrors, prisms, or other optical components such as gratings or holographic optical elements (HOE).

The disclosed external cavity is usable for conventional LDA's, in which the front facet has a reflectivity such as 5-8% as the front cavity of the LDA waveguide. This front end reflectivity can be modified to assist the external cavity mode competition and to increase the efficiency. When the reflectivity of the LDA front facet is close to zero, it is necessary to have an external cavity for the LDA to form the front cavity. Besides rear cavity, it is necessary for LDA to have a front cavity, which can be formed with an external cavity.

The disclosed external cavity is also usable for BAL's and laser diode stacks.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a schematic that shows the reflection of a beam by a volume grating. FIG. 1(a) shows the layers (lateral layers) with the same refractive index in a grating can be parallel to the surface plane of the grating. FIG. (b) indicates that they can also form a large angle with the surface.

FIG. 2 illustrates the divergence angle of a laser diode in its slow axis.

FIG. 3 shows a few structures for controlling BAL divergence using volume grating TBG as external cavity. FIG. 3(a) illustrates the beam emitted from BAL in fast axis is collimated by cylindrical lens FAC and go through TBG. FIG. 3(b) shows the path of beam in the slow axis, where part of the beam through the cylindrical lens FAC is reflected by a type of volume grating TBG. FIG. 3(c) shows a beam path in the slow axis, where a different type of volume grating TBG is used.

FIG. 4 shows the embodiments of using volume grating TBG for beam quality control of laser diode arrays. FIG. 4(a) is the view showing the LDA collimated beam by FAC. FIG. 4(b) illustrates the slow axis views of one embodiment where one type of volume gratings is used for beam quality control for LDA along with a feedback prism P. FIG. 4(c) illustrates another embodiment when another type of volume gratings is used with a mirror M for beam quality control for LDA.

FIG. 5 is a schematic for controlling the divergence angle of LDA with normal incident, high reflectivity volume grating TBG as external cavity. FIG. 5(a) shows the beam path with collimation in the fast axis. FIG. 5(b) is the beam path in slow axis direction, where TBG and LDA form a small angle.

FIG. 6 is a schematic view of another embodiment for LDA beam control with volume grating TBG, where a telescope is used in the cavity with a volume grating TBG.

FIG. 7 is a schematic view of yet another embodiment for LDA beam control with volume grating TBG, where a negative lens system is used as the eyepiece of telescope.

FIG. 8 illustrates yet another embodiment using a volume grating for beam quality control along with a prism as a variation of cylindrical telescopes.

FIG. 9 is a schematic of the external cavity for LDA feedback formed with prism “telescope” and mirror.

FIG. 10(a) and FIG. 10(b) illustrate, respectively, slow axis and fast axis views of another embodiment where conventional optical components, instead of volume grating, is used to form the external cavity for feedback with good angular selectivity. FIG. 10(c) shows the beam path in the fast axis direction for an embodiment where a spherical mirror is used as the cavity structure for the beam quality control of an LDA stack.

FIG. 11 shows yet another embodiment of using conventional optics for feedback beam quality control where a right angle prism PM is used.

FIG. 12 shows yet another embodiment that is similar as the one shown in FIG. 11, where the distance of objective OB and LDA is made equal to focal length f1.

FIG. 13(a) and FIG. 13(b) are schematic views of slow axis and fast axis, respectively, of an embodiment using a planar mirror for feedback.

### DESCRIPTION OF THE INVENTION AND THE PREFERRED EMBODIMENTS

Angular Selectivity of Volume Gratings

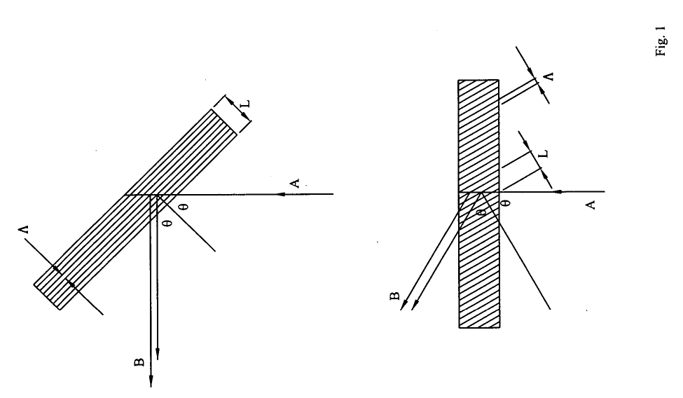

FIG. 1 is a schematic that shows the reflection of a beam by a volume grating. In a medium with a thickness of L and a refractive index of n, periodic modulation of the refractive index forms a volume grating with a period of Λ. Given the angle between incident beam A and the normal of grating being θ, when Bragg condition is satisfied:
α=2Λ cosθ=λ
the interference of all reflective wavefront formed by the grating will reinforce, leading to high reflectivity and generating reflection beam B, where λ is the wavelength of the incident beam and α=2nΛ cosθ is the optical path difference of two neighboring beam. When the incident angle θ is changed by Δθ, the change in optical path difference is
α=2nΛ sin θ·Δθ.

When sinθ=0, Δα=0. In other words, the change in the optical path difference caused by Δθ is an infinitesimal of the second order. In this case, the reflectivity of volume grating is not sensitive to the change of incident angle. This is the reason that Volodin et al fails to restrict the divergence angle of laser diode by using volume grating.

In order to make volume grating have high reflectivity change for different incident angle, sin θ should have appropriate large value. Since the biggest optical path difference Δαₘ is
Δαₘ=2nL sin θ·Δθ,
when Δαₘ=λ, or when the change in maximum optical path difference caused by Δθ is one wavelength, the reflective waves of the grating will interfere and cancel each other into 0. The reflectivity of the grating will change from maximum to zero. It can be seen that the thicker the grating, the larger Sin θ is, the higher the angular selectivity. When sin θ=0, the angular selectivity is the smallest. For example, when L=0.5 mm, λ=1 μm, n=1.5, when sin θ=0.7, Δθ=0.001. For the same grating, if sinθ=0, cosθ=1 Bragg condition is satisfied. If to make a 1 μm change in optical path difference, sin θ′ can be found to be 0.036. In this case, the reflectivity of the grating will change to zero when the incident angle changes from 0° to 2°. Comparing with 45° situation, the selectivity is decreased by a factor of 36.

Therefore, it is preferred to use thick volume grating with large slant angle as a “reflection surface” with angular selectivity for laser mode selection or laser mode restriction. In this way, it is easy to improve the divergence angle.

Thick Bragg grating (TBG) itself is known to have selectivity in reflectivity for different wavelengths.

A volume grating in a medium can exist in different forms, such as shown in FIG. 1(a) and FIG. 1(b). The layers (lateral layers) with the same refractive index in a grating can be parallel to the surface plane of the grating (FIG. 1(a)). They can also form a large angle with the surface, such as in Fig. (b). Such difference in geometric structure does not affect the basic properties of TBG.

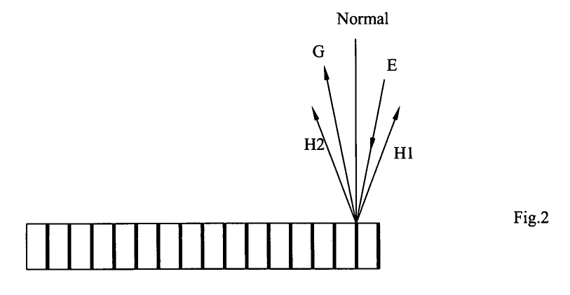

FIG. 2 illustrates the divergence angle of a laser diode in its slow axis. In this figure, only one emitter of the LAD is shown to emit beams H1 and H2, which are symmetric to the normal of the surface. The divergence angle (FWHM) is normally between 6° to 10° for most of the commercial LDA. This angle is determined by the techniques of laser diodes. The beams in the direction E, G with the maximum gain are also symmetric to the surface normal, and are two lobes of high order modes of the laser diode waveguide. The angle between E and G is smaller than that of H1 and H2, but is larger than zero. In this invention, we will choose direction E is the direction of external cavity feedback into the LDA (or BAL or LD stack), wherein G is the direction of laser output; and vise versa.

The width of the emitter in LDA is often between 100 μm to 200 μm in slow axis. Therefore, the beam emitting from the emitter in G (or E) direction also has a certain divergence. The diffraction limit of this divergence angle is 10 mrad to 5 mrad (when wavelength is 1 μm). If the beam fed back from the external cavity does not match with this divergence angle, it will not be able to enter the LDA waveguide completely even if the beam direction is correct, leading to cavity loss. The efficiency of LDA will thus decrease. Nevertheless, an external cavity that matches perfectly is difficult to obtain. It must be able to feed back all the beams of a given divergence range emitted from an emitter of a given size. If only part of the beam is fed back, there will be loss of efficiency caused by the cavity structure. With the understanding of the principle, it is clear that not only can volume grating can be used for beam quality control, conventional optical components can also be used for external cavity to achieve the same results as to be described below.

### Embodiment 1

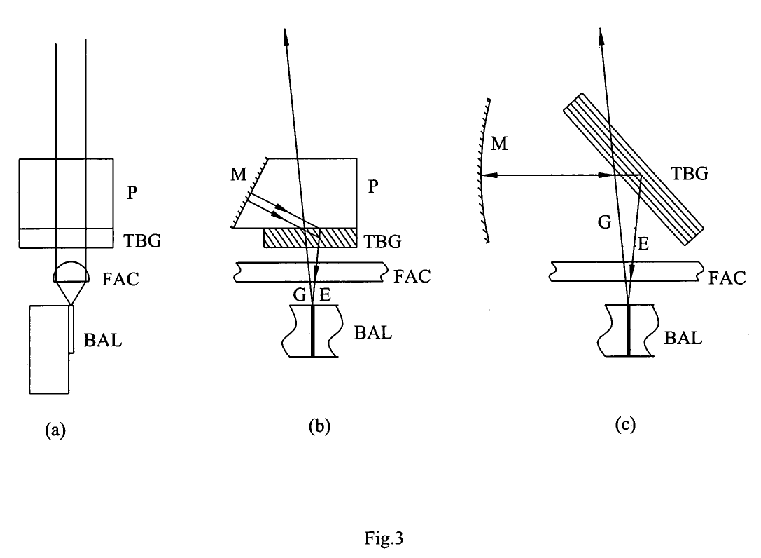

A structure for controlling BAL divergence using large incident angle volume grating TBG as external cavity is shown in FIG. 3. FIG. 3(a) illustrates the beam emitted from BAL in fast axis is collimated by a cylindrical lens FAC and goes through TBG. FIG. 3(b) shows the path of beam in the slow axis, where part of the beam through the cylindrical lens FAC is reflected by the volume grating TBG, which has high reflectivity because Bragg condition is substantially satisfied. The reflected beam going through prism P is again reflected back along the same path by the mirror surface M of prism P. This reflected beam enters the BAL waveguide and emits as laser beam G. Since the direction of beam G is different from E, Bragg condition is not satisfied and G has a high transmissivity when going through TBG. In this embodiment, prism P is used to avoid total reflection of beam from the TBG surface.

The above setup works well when beam E is fully collimated. Due to diffraction, however, beam always has a certain divergence. When the distance of transmission increases, the beam spot will become larger and will exceed the emitter dimension when the beam is reflected back. Therefore, it is more advantageous to make the path length in FIG. 3 as short as possible.

For BAL, if the mirror surface M is a spherical with the center of the sphere located at the BAL surface, the diffraction loss can be decreased.

FIG. 3(c) shows a beam path in the slow axis, where a different type of volume grating TBG is used. The beam E from BAL, after being reflected in a large angle by the volume grating, reflected back by spherical mirror M to where it is emitted and generate laser beam G as the output.

### Embodiment 2

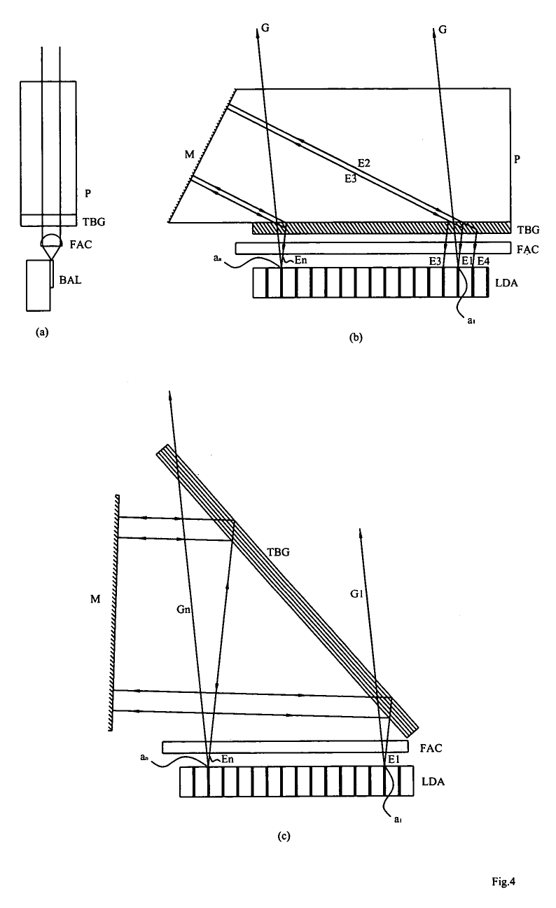

A structure for controlling LDA divergence using large incident angle volume grating TBG as external cavity is shown in FIG. 4. In FIG. 4(a), the beam from LDA is collimated by a cylindrical lens FAC in the fast axis and pass through TBG. FIG. 4(b) shows the beam path in the slow axis. LDA is commonly formed with multiple emitters in an array. In FIG. 4(b), the LDA has 14 emitters. Since the beam path of each emitter is the same, the only beam paths of two emitters a₁, and aₙ are shown. After passing through FAC, part of the beam E1 from a₁ is reflected into E2 and E3 by volume grating TBG. E2 and E3 are then reflected back to a₁ by mirror M of prism P along the path they reach M, and emit as laser beam G1. TBG satisfying the Bragg condition for E1 emitted from LDA, and thus has high reflectivity for beam E1. G1 has a different transmission direction from E1. Since the Bragg condition is not satisfied, TBG has high transmissivity for G1, which then pass through prism P as the laser output. As in embodiment 1, the purpose of the prism is to avoid total reflection from the surface of TBG.

The “reflection” of a volume grating is the result of Bragg diffraction. Unlike the reflection from a planar mirror, the thickness of volume grating will broaden the beam involved. For example, the thin beam E1 in FIG. 4(b) is diffracted into E2 and E3, which is reflected by mirror M along the original path back and further diffracted by TBG into E3 and E4. The amount of broadening is determined by the thickness of TBG, but also correlated with the angle of Bragg reflection. This kind of broadening will cause the loss in external cavity. On the other hand, it can also stimulate the synchronous oscillation of neighboring emitters when any particular one of the emitters in the LDA oscillates. This sequential process can cause all the emitters coherently synchronized, reducing the divergence angle in the slow axis.

FIG. 4(c) illustrates a beam path in slow axis where another kind of volume grating TBG is used.

Laser diode array stack is made from many LDA's grouped together in parallel. The structure in FIG. 4 can be used for each LDA in a LDA stack. Therefore, all the LDA's in the stack can also have a cavity at the same time.

### Embodiment 3

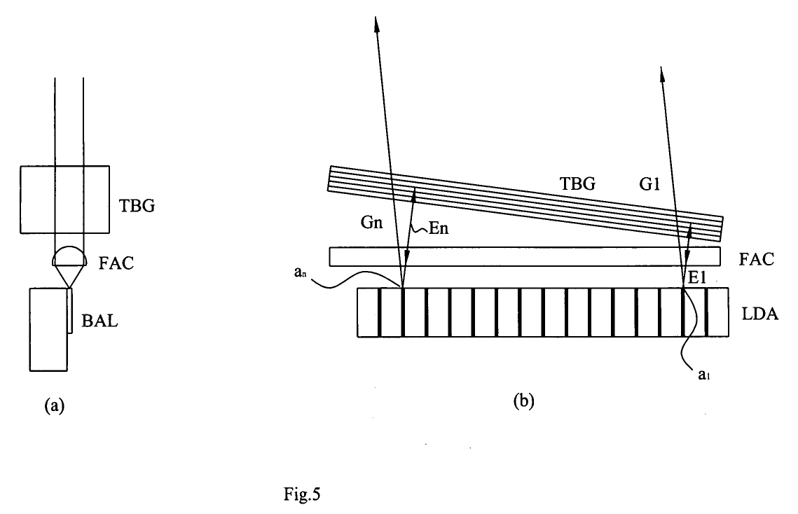

FIG. 5 is a schematic for controlling the divergence angle of LDA with normal incident, high reflectivity volume grating TBG as the external cavity. FIG. 5(a) shows the beam path with collimation in the fast axis. FIG. 5(b) is the beam path in slow axis direction, where TBG and LDA form a small angle. The beams E1 . . . En emitted from the LDA with multiple emitters have the same direction as the normal of grating TBG. Moreover, TBG satisfies the Bragg condition for the beams E1 . . . En emitted from LDA and has high reflectivity. E1 . . . . En are reflected back to LDA and form laser beam G1 . . . Gn as the output, which have a high transmissivity on TBG. From the theory of volume grating, if incident angle θ=0 and Bragg condition is satisfied, high reflectivity will still remain if the angle difference is only a few degrees. Unlike large incident angle volume grating, the beams that have directions close to E1 . . . En (such as 1 degree) also have high reflectivity on this volume grating. Therefore, there are a group of beams that can be fed back to LDA surface. Because of this, normal incident angle scheme has lower angular selectivity than large incident angle schemes. Not all the beams can enter the waveguides of the emitters when the beams are fed back. If the distance between LDA and TBG is increased, the diffraction loss of the collimated beam E1. En will increase, and the probability of entering the waveguide becomes even smaller for beams that have non-perpendicular incident angle with TBG. This situation is similar to the long cavity used in conventional solid-state lasers.

It should be noted that the structure in FIG. 5 can also be applied to LDA stacks.

### Embodiment 4

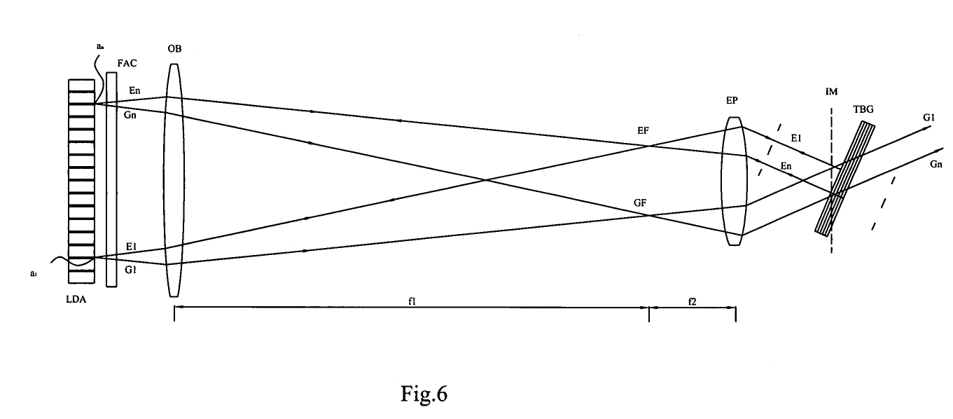

To enhance the angular selectivity for normal incident volume grating, a telescope can be added in the cavity. The theory indicates that the angular selectivity of normal incident volume grating is an order of magnitude lower than that of large incident angle grating. However, it is possible to increase the angle difference by several times or even several ten times with a telescope. Such structure is show in FIG. 6, where the optical path in slow axis is illustrated. The parallel beams E1 . . . En from LDA after FAC are focused by objective OB at focal point EF, which are then turned into parallel beams again by eyepiece EP. The angle between the beams and the axis are increased for m times, where m=f1/f2 and f1 and f2 are the focal length of objective OB and eyepiece EP, respectively. The beams E1. En after the eyepiece incident perpendicularly on the volume grating TBG are then reflected back to LDA with high reflectivity, enter the respective emitter waveguide, and then generate output laser beams G1 . . . Gn through the telescope, with the direction symmetric with E1 . . . En.

The plane position IM in FIG. 6 is the exit pupil of the telescope, or is the image plane of the LDA emitter. When TBG is at position IM, there will be no diffraction loss for the beam reflected and fed back to LDA. The beam emitted from LDA with certain divergence angle will all be reflected back to the original position.

TBG can also be moved forward or backward to the dot line position in FIG. 6. At these positions, the feedback beams E1 . . . En are totally separated from output laser beams G1 . . . Gn, and the dimension of TBG can be very small. The output laser beams G1 . . . Gn do not pass through TBG. In this case, planar mirror can be used to replace TBG to form external cavity. The angular selectivity can be lower.

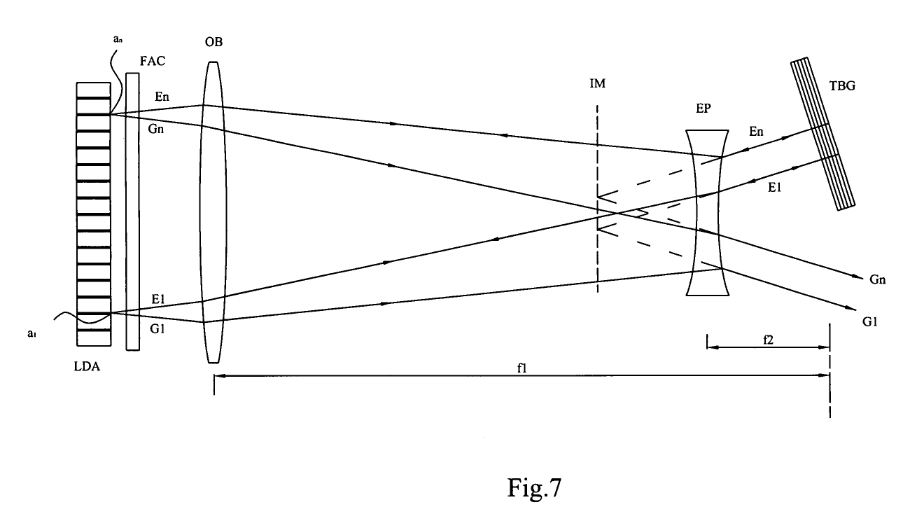

FIG. 7 is similar to FIG. 6, where negative lens system with focal length −f2 is used as the eyepiece of telescope. In this case, exit pupil IM is a virtual image located in the telescope. The output laser beams after the eyepiece is completely separated from the feedback beam, and therefore TBG can be replaced with a planar mirror.

Since only angular magnification is needed in the slow axis, the telescopes described in the above embodiments can comprise a cylindrical optics such as cylindrical telescope, instead of axially symmetric optical systems. With cylindrical optics, angular magnification can be made to be only in the slow axis.

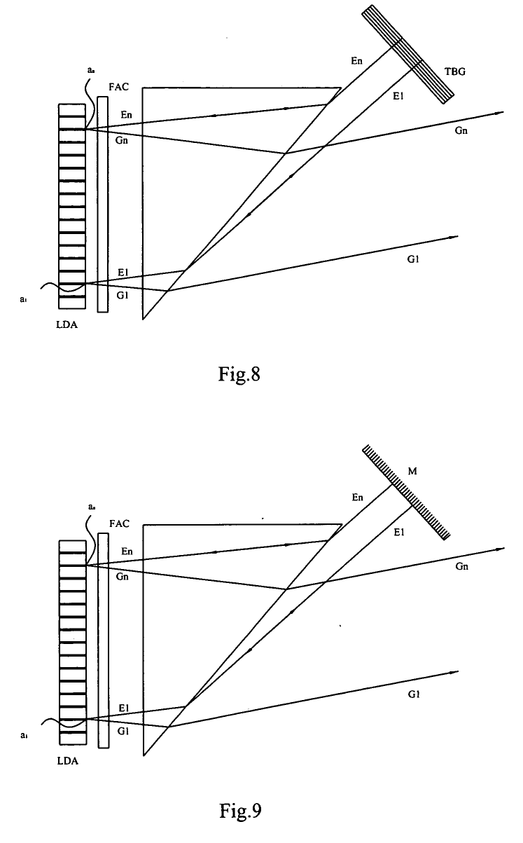

It is well known that the functions of cylindrical telescope can be accomplished with a prism as shown in FIG. 8. At the angle close to grazing incidence angle, it is easy to obtain high angular magnification. The structure can be made very small.

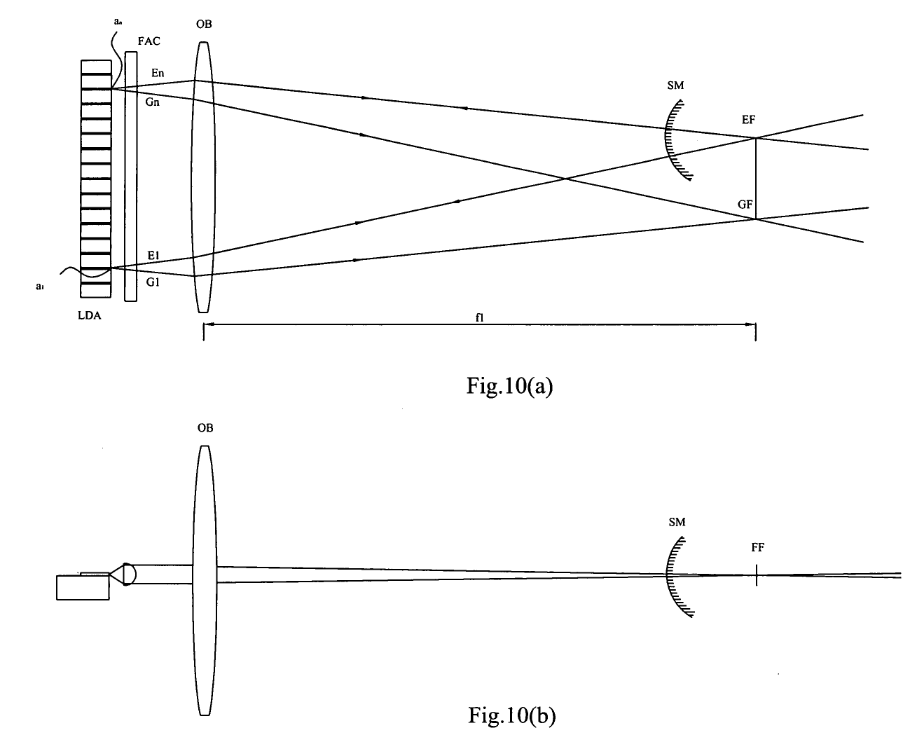

By increasing the angular selectivity using high magnification telescope, planar mirror M1 can be used directly to replace TBG for feedback. Although the result could make the angular selectivity slightly lower, the structure is simple and convenient. FIG. 9 is a schematic of the external cavity for LDA feedback formed with prism “telescope” and mirror.

It should be noted that the cavity structure using cylindrical telescope can also be used for LDA stacks.

### Embodiment 5

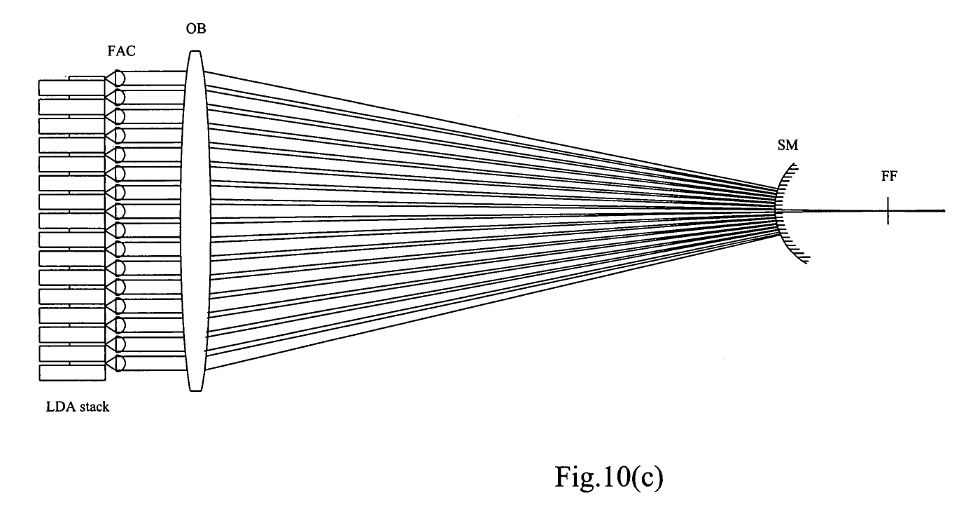

Conventional optical components can also be used to form external cavity for feedback with good angular selectivity. One of the structures is shown in FIG. 10. The beams from the LDA with multiple emitters are collimated by the cylindrical lens FAC in fast axis, as shown in FIG. 10(b), and then focused at focal point FF by objective OB having a focal length of f1. For the slow axis diverging beams E1 G1 and EnGn emitted from each emitter (other beams are not shown as in some other embodiments), beams E1En and G1 Gn that are parallel to each other are focused on the same focal plane. The corresponding focal point EF, GF form a focal line, as show in FIG. 10(a). With a spherical mirror SM with the center of sphere being coincide with EF (coincide with FF in fast axis), beams E1En are reflected back along the original path to LDA and form laser output G1 Gn in the symmetric direction.

The cavity structure using spherical mirror for feedback can also be used for LDA stacks. In this case, the slow axis beam path for each LDA in the stack can still be illustrated with FIG. 10(a). FIG. 10(c) shows the beam path in the fast axis direction. Each LDA is collimated by corresponding FAC in the fast axis direction. The beams that are parallel to each other are then focused at point FF by objective OB. The beams are reflected back by mirror SM along the original path.

In FIG. 10, a convex spherical mirror is used as the external cavity. It is also possible to use concave spherical mirror with its center of sphere being at EF. In this case a different external cavity with different parameters can be made. The smaller the radius of the spherical mirror is, the higher the angular selectivity.

### Embodiment 6

In the previous examples, in order to reflect the beams focused at EF back, spherical mirrors are used. It is well-known that many other optical components can be also used to accomplish this task. For example, if the corner point of a corner cube is made coincide with focal point EF in FIG. 10, E1En will be made to return along the original path that the beams come from.

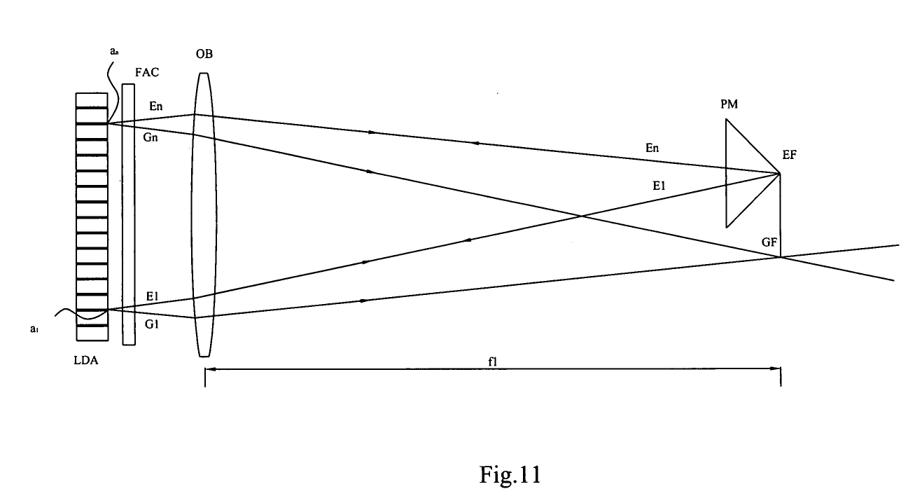

FIG. 11 is an example using right angle prism PM. By arranging the roof edge of the prism perpendicular to the focal line (EF-GF) and the roof edge passing point EF, beams E1En will return along the path the beams come from and form laser output G1Gn.

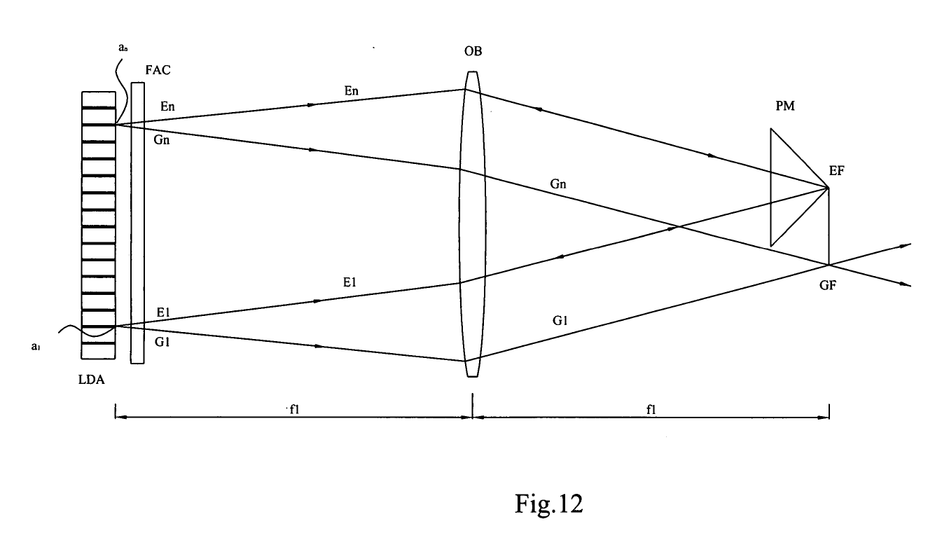

The difference of the scheme in FIG. 12 from FIG. 11 is that the distance of objective OB and LDA is made equal to focal length f1. OB becomes the collimator for the beams in slow axis. The diverging beam from any point of LDA after being collimated by OB is reflected back by the right angle prism along the original path to the point the beam was emitted. In FIG. 11, only the LDA beams that are parallel to E1En can be reflected back by the right angle prism along the path the beam was emitted. Therefore, the optical scheme in FIG. 12 is an external cavity with less loss. By controlling the size the prism, the divergence angle for feedback can be controlled. It is also possible to reach diffraction limited by properly select the size of the prism. For an LDA stack, the prism PM should be a corner cube, or the objective OB should be a cylindrical lens.

### Embodiment 7

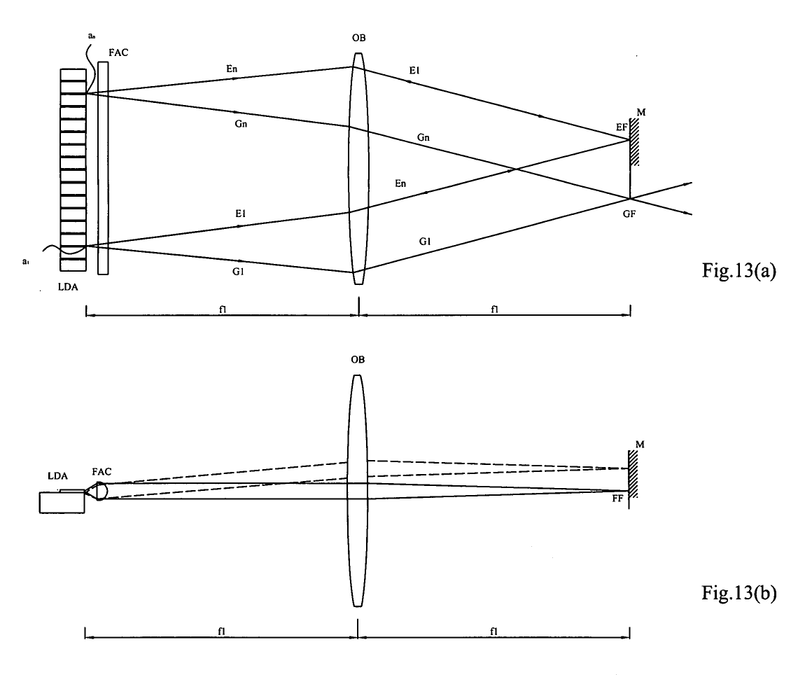

When a planar mirror is used for feedback, only the parallel beam in the direction of normal can be reflected back along the original path. Other parallel beams after reflection form another set of parallel beams symmetric to the normal. By taking advantages of this characteristic, efficient improvement to divergence angle can be achieved. In FIG. 13(a), beams emitted from evenly distributed emitters of LDA, after collimated by objective OB in slow axis, become multiple beams with even angular distribution. In other words, the angles of each two neighboring beams are the same. When the normal of a plane mirror is placed at the symmetric center of these beams and the focal point of the beam is at the mirror surface, these beams will be reflected in alternate pairs back to LDA by the planar mirror. FIG. 13(a) shows the external cavity of LDA comprising small planar mirror M, slow axis collimating objective OB, and fast axis collimating objective FAC. Comparing with FIG. 12, M is used to replace prism PM, and E1En is not fed back along the original path, instead, E1 enters the beam path of En and En enters the beam path of E1, alternatively, causing synchronous oscillation of emitters a₁ and aₙ. In this case, laser beam G1 and Gn are coherent, which is beneficial the reduction of divergence angle.

The same as Embodiment 6, limiting the dimension of M in slow axis direction can limit the laser divergence angle of LDA in the slow axis direction. It is also possible to make divergence angle close to be diffraction limited.

FIG. 13(b) is the corresponding beam path in the fast axis direction, showing that the beams from LDA is collimated by FAC in the fast axis and then focused at focal point FF. When mirror M is perpendicular to the optical axis, beams can be reflected back to the emitters of LDA along the original path. The dot line in FIG. 13(b) illustrates the situation when there is smile in LDA, that is, the emitters of LDA are not arranged in a straight line. In this case, some of the emitters will not be on the optical axis due to the smile. After FAC collimation, the beams from these emitters will become out-of-axis, as shown by the dot lines in FIG. 13(b). The angle of dot line from the axis is determined by the ratio between the dimension of smile and focal length of FAC. If the distance between FAC and OB is close to the focal length, this beam will still be close to be parallel with the axis after OB, and mirror M still can reflect it back along the path it comes from. Therefore, the external cavity in this embodiment will be effective even if the LDA has a small smile. Of course, the existence of smile will enlarge the beam divergence in the fast axis.

The above discussion will hold also for cases where prism is used as external cavity for feedback such as in Embodiment 6.

By replacing M in FIG. 13 with a planar grating, the oscillation of LDA can be confined to a specific wavelength.

The method of using plane mirror as the external cavity can also be used for LDA stacks. In this case, it is better to use cylindrical optical system as the objective OB. When OB is an axially symmetric optics, the distance between neighboring LDA's should be made as equal as possible in order to make efficient feedback coupling between each pair of the symmetric LDA's.

In summary, the above discloses a laser apparatus comprising a semiconductor laser element having a first output cavity facet and a second external cavity means that forms a resonator cavity with the first output cavity facet. The beam from the semiconductor laser element can be collimated easily with a fast axis collimator. The output cavity facet of the semiconductor laser can be coated properly to optimize the performance. The external cavity means reflects the beam from the first output facet and injects the beam back to semiconductor laser element in a predetermined direction, preferably in a direction with maximum gain, and generates a laser output in a different direction. The external cavity means can be a volume grating or an optical system, in which the volume grating or optical system and the output cavity facet forms the resonator cavity and the volume grating or optical system control the beam quality of the laser output by restrict the oscillation mode in the cavity. As shown in some embodiments, a reflector can be used together with the volume grating, in which the reflector acts as the cavity mirror and the volume grating serves the function of restricting oscillation mode. When a volume grating is used as the external cavity, an optical system can be used within the cavity to enhance the beam quality control capability of the volume grating. Selectivity can be enhanced. Also, as shown in some of the embodiments, when a conventional optics such as a reflector optical system is used as the external cavity to form the resonator cavity with the first output cavity facet, the oscillation mode can be well restricted. Therefore, the mode of the laser output or the beam quality can be controlled. The advantage and availability of using conventional optical components are obvious. When the method disclosed here is used with LDA or 2D LDA stacks, high power beam can be obtained with a beam quality as good as near diffraction limited.

The foregoing descriptions of embodiments of the invention have been presented for the purpose of illustration and description, which thereby enable others skilled in the art to best utilize the present invention. It is not intended to limit the invention to the precise form disclosed, and obviously many modification and variation are possible in light of above teaching for the skilled in the art. For example, in most of the embodiments, the front mirror of diode laser is used as a cavity mirror along with only one external cavity mirror for beam quality control. However, another external cavity mirror could be added to replace or “override” the front cavity mirror of the emitter of a laser diode. The reflectivity of the front mirror for the emitter of a laser diode can also be controlled to affect the beam quality control. On the other hand, the feedback schemes disclosed here can also be miniaturized by including the external cavity structures on wafer level during the fabrication of the laser diode to achieve high beam quality. Moreover, the first output cavity mirror can be made as a component independent from the semiconductor laser element, or as another external cavity mirror. This mirror can be in different forms also. When another external cavity mirror is used, the front facet of the semiconductor laser facet can be coated with an anti-reflection coating. While specific values have been used and listed in the foregoing embodiments, the invention teaching is properly described in the claims.

We claim:

1. A laser apparatus comprising:
a semiconductor laser element having a first output cavity facet,
a second external cavity means forming a resonator cavity with said first output cavity facet, wherein said external cavity means reflects the beam from said first output facet and injects said beam back to said laser element in a predetermined direction and generates a laser output in a different direction.

2. The laser apparatus of claim 1, wherein said external cavity means comprising a volume grating, wherein said volume grating and said first output cavity facet forms the resonator cavity and whereby said volume grating controls the beam quality of the laser output by restrict the oscillation mode in the cavity.

3. The laser apparatus of claim 1, wherein said external cavity means comprising a volume grating and a reflector, wherein said reflector and said first output cavity facet form the resonator cavity and said volume grating placed within the resonator cavity restricts the oscillation mode in the cavity and thus determines the mode of the laser output.

4. The laser apparatus of claim 1, comprising a fast axis collimation optics disposed in said resonant cavity and next to said first output cavity facet, collimating said beam in the fast axis.

5. The laser apparatus of claim 2, further including an optical system placed within the cavity to enhance the beam quality control capability of said volume grating.

6. The laser apparatus of claim 5, wherein said optical system includes a telescope optical system.

7. The laser apparatus of claim 5, wherein said optical system includes a prism.

8. The laser apparatus of claim 1, wherein said external cavity means comprising a reflector optical system, wherein said reflector optical system and said first output cavity facet form the resonator cavity and said reflector optical system restricts the oscillation mode in the cavity and thus determines the mode of the laser output.

9. The laser apparatus of claim 1, where the disclosed external cavity comprises an optical system that focus beams from a predetermined direction, and a reflector that is located at the focal point of said optical system to send beam at the focal point back from the path they come.

10. The laser apparatus of claim 8, wherein said reflector optical system comprising a spherical mirror.

11. The laser apparatus of claim 8, wherein said reflector optical system comprising a prism.

12. The laser apparatus of claim 8, wherein said reflector optical system comprising a planar mirror.

13. The laser apparatus of claim 1, wherein said laser element is a laser diode array.

14. The laser apparatus of claim 1, wherein said laser element is a 2D laser diode array stack.

15. The laser apparatus of claim 1, wherein said first output cavity facet comprising a reflection means detached from said a semiconductor laser element.
